(19) United States
(12) Patent Application Publication
(10) Pub. No.: US 2004/0001258 A1
(43) Pub. Date: Jan. 1, 2004

(54) Solid state etalons with low thermally-induced optical path length change

(76) Inventor: Mandeep Singh, Ottawa (CA)

Correspondence Address: Samuels, Gauthier & Stevens, LLP, Attn: William E. Hilton, 225 Franklin Street, Suite 3300, Boston, MA, 02110, US

(21) Appl. No.: 10/218,753

(22) Filed: Aug. 14, 2002

Related U.S. Application Data
(60) Provisional application No. 60/392,342, filed on Jun. 28, 2002.
(60) Provisional application No. 60/399,887, filed on Jul. 31, 2002.

(51) Int. Cl. G02B 27/00

(52) U.S. Cl. 359/578

(57) ABSTRACT

An etalon is disclosed comprising a first material having a first coefficient of thermal optical path length change μ₁, a second material having a second coefficient of thermal optical path length change μ₂, and an optical path extending through the first material and the second material, wherein one of μ₁ and μ₂ is negative. Etalons composed of a single crystalline material are also disclosed. Such materials include crystalline quartz.

### PRIORITY INFORMATION

This application claims priority from provisional application Ser. No. 60/392,342 filed Jun. 28, 2002 as well as provisional application Ser. No. 60/___,____ filed Jul. 31, 2002.

### BACKGROUND

The invention relates to passive optical devices and particularly to etalons used to filter, select or transmit a narrow bandwidth of optical frequency from an optical beam or signal having a broader optical frequency bandwidth. In particular, the invention relates to etalons used in optical telecommunication systems where there is a demand for selecting or transmitting very narrow discrete optical frequency bandwidths of predetermined optical frequency from a broadband optical signal. Such predetermined discrete optical frequencies or channels may comprise standardized communication channels, usually in the near-infrared spectral region (800 nm to 2000 nm), most particularly the portions of the spectrum commonly designated as C and L bands, covering the wavelength range 1520 nm to 1620 nm approximately, most suited for dense wavelength division multiplexing (DWDM) of the communications channels. Recently there has been a need to distinguish even narrower channel bandwidths thereby enabling the use of more channels having more closely spaced discrete mean frequencies. Accordingly, it is a critical aspect of optical telecommunications passive elements that they may continuously operate to select, transmit or receive optical signals having very narrow discrete optical frequencies.

In optical telecommunication systems, there have been a number of recent developments in the use and fabrication of etalons to control the optical frequency transmission range of the etalon cavity. In solid-state etalons, great care is taken to use homogeneous optical materials to provide a solid etalon cavity with a uniform refractive index throughout. In addition, recent developments have lead to the ability to more precisely measure and fabricate solid etalon cavity material thickness to generate etalon cavities with narrow band pass characteristics while at the same time being centered upon a predetermined discrete optical frequency range. In air-space or gas-space or vacuum chamber etalons, these same measurement and fabrication techniques have been used to fabricate the gas filled or evacuated etalon cavity thickness by controlling the dimension of a unitary spacer material or discrete spacer elements that define the etalon cavity thickness. Such techniques may control the cavity thickness to provide etalon cavities with thickness variations within a range of about 20-200 nanometers.

FIG. 1A depicts a conventional solid etalon 10A and FIG. 1B depicts a conventional gas filled or evacuated etalon 10B. Each etalon 10A, 10B includes an upper material 20A, 20B and a lower material 25A, 25B, each of which is formed of a glass or crystal substrate polished with end faces parallel to within a few seconds of arc, with dielectric 2 partial or one partial and one high reflectance coatings on either side. Each element includes a cavity 30A, 30B having a cavity length 35A, 35B. In the air-space etalon 10B, careful fabrication of the spacers 40B, which may comprise separate elements or an annular element, is used to control the cavity length 35B, while in the solid etalon 10A, careful control of the thickness of the solid etalon material is used to control the cavity length 35A. In general, each etalon cavity 30A, 30B includes an input surface 45A, 45B and an output surface 50A, 50B that are optically coated to enhance the performance of the cavity. A laser (usually wavelegth-tunable) or broad-band optical beam 55A, 55B or optical signal, having an optical frequency or an optical wavelength (λ) and an optical frequency or optical wavelength bandwidth (Δλ) enters the etalon 10A, 10B from an input side at substantially normal incidence with respect to the cavity 30A, 30B and first passes through the input window 20A, 20B, into the etalon cavity 30A, 30B and exits through the output window 25A, 25B.

In operation, the etalon cavity length 35A, 35B and refractive index (n) of the cavity material are selected to provide destructive phase interference between the entering beam or signal 55A, 55B and a reflected beam or signal 60A, 60B that is reflected from the output face 50A, 50B. Such a destructive interference occurs when the cavity length 35A, 35B is an integer multiple of one half the wavelength, (Nλ/2), where N is an integer. Conversely, the cavity 30A, 30B will have a maximum optical signal transmission when the cavity length 35A, 35B is an integer multiple of one half the wavelength (Nλ/2)—in this case the cavity is said to be in resonance.

The optical path length (OPL), or optical phase thickness (φ) in radians of an etalon cavity is given by:

$$φ = \frac{2 π}{λ} nd cos θ \qquad ( 1 )$$

where n is the index of the cavity material, d is the cavity length 35A, 35B, λ is the optical wavelength of the optical signal beam and θ is the propagation angle that the input beam 55A, 55B induces within the cavity input surface 45A, 45B. By taking the case of near-normal angle of incidence of the light beam, the cos θ approximates to 1, and equation 1 becomes a function of only n, d and λ. At optical frequencies used in telecommunications e.g., 193 GHz, the wavelength of the signal beam is approximately 1553.37 nanometers, (nm). Accordingly a change in the etalon cavity length of only a few hundred nm can significantly change the performance of the etalon.

One problem with the conventional etalons described above is that there is a frequency band pass (resonance peak) drift, which is dependent on the etalon cavity temperature, and this frequency band pass drift is unacceptable and undesirable in more recent telecommunications systems. One solution to the problem is to precisely control the operating temperature of the optical system such as with a thermal controller (cooler/heater), or the like, attached to or near the etalon to precisely control the temperature of the etalon. Alternatively, a climate control system may be provided to precisely control the environment temperature of the optical system. However these solutions have proven to be expensive and impractical in certain telecommunications systems. In addition, the desired degree of precise temperature control is usually not attainable. For example in the example given above, the change in etalon cavity linear length may result from only a small temperature change when using fused silica as a solid etalon cavity material. In addition, the indices of refraction of the etalon material (solid and gas) also vary with temperature and this leads to further performance degradation with changing temperature if these two variations do not compensate each other.

Accordingly there is a need in the art to maintain uniform etalon cavity transmission characteristics over a range of temperatures.

### SUMMARY OF THE INVENTION

The invention provides an etalon comprising optically homogeneous materials especially crystalline materials that exhibit thermally induced optical path length characteristics superior to those of typical glasses and fused silica. Such materials include crystalline quartz (0001) with the direction of light propagation parallel to the optical or c-axis. The invention also provides an etalon comprising a first material having a first coefficient of thermal optical path length change β₁, a second material having a second coefficient of thermal optical path length change β₂, and an optical path extending through the first material and the second material, wherein one of β₁ and β₂ is negative. In an embodiment the first material is a crystal e.g. rutile or strontium titanate (with negative β) and the second material is a glass e.g., BK 7 or a crystal e.g., quartz (0001) (with positive β). The resultant optical path length is determined by the desired free spectral range (FSR) of the etalon, and the partition ratio of the two materials is set such that the overall thermally-induced optical path length change is compensated to an effective value approaching zero.

### BRIEF DESCRIPTION OF THE DRAWINGS

The following detailed description may be further understood with reference to the accompanying drawings in which:

FIGS. 1A and 1B show illustrative diagrammatic views of prior art etalons;

FIG. 2 shows an illustrative diagrammatic view of an etalon in accordance with an embodiment of the invention;

FIG. 3 shows an illustrative diagrammatic view of an etalon cavity in accordance with another embodiment of the invention;

FIG. 4 shows an illustrative diagrammatic view of an etalon cavity in accordance with a further embodiment of the invention; and

FIG. 5 shows an illustrative diagrammatic view of an etalon cavity in accordance with a further embodiment of the invention.

The drawings are shown for illustrative purposes only and are not to scale.

### DETAILED DESCRIPTION OF THE ILLUSTRATED EMBODIMENTS

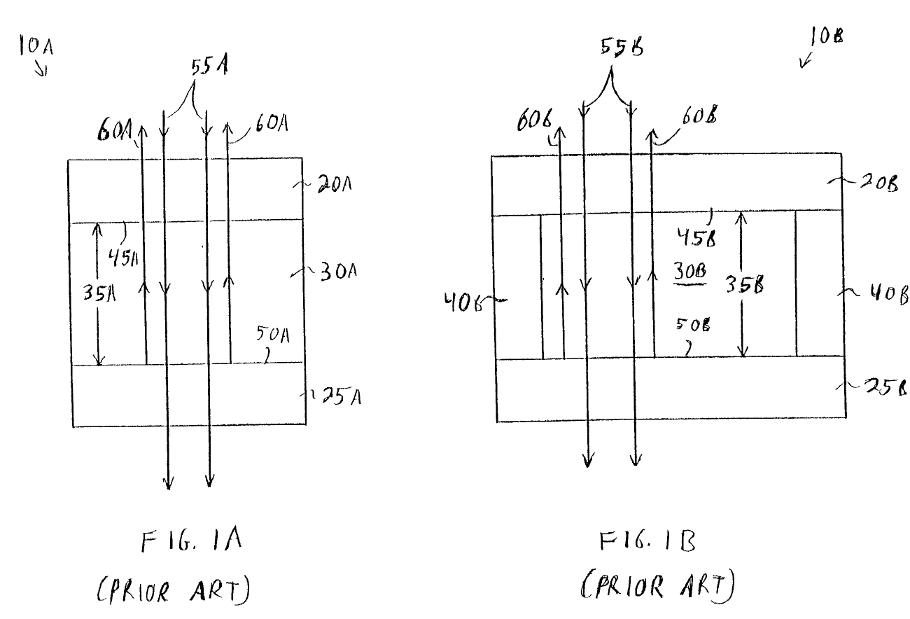

As discussed above with reference to FIGS. 1A and 1B, changes in the OPL of an etalon cavity with respect to temperature are affected by the change in refractive index of the cavity material (n) with respect to temperature (T), (dn/dT) and changes in the linear length of the cavity (d) with respect to temperature. In a solid etalon, the linear length change is given by dαₑ where αₑ is the linear coefficient of thermal expansion of the etalon material. In a gas or evacuated etalon, the linear length change is given by dαₛ where αₛ is the linear coefficient of thermal expansion of the spacer material.

To determine the thermal sensitivity of an etalon cavity, the phase thickness as in equation (1) is differentiated with respect to temperature assuming cos θ≈1 (near-normal incidence operation) and a near-zero extinction coefficient. The change in phase thickness with temperature T is then given (in radians) by:

$$Δ φ = \frac{2 π nd}{λ} [ α + \frac{1}{n} \frac{ⅆ n}{ⅆ T} ] Δ T \qquad ( 2 )$$

where α is the coefficient of linear thermal expansion of the optical cavity material. Accordingly, a temperature coefficient of optical path length β of a homogeneous isotropic material (or of a uniaxial anisotropic crystal with a (0001) incidence plane and propagation parallel to the optical (c-axis)) is given (in units of K⁻¹) as:

$$β = \frac{λ}{2 π nd} \frac{Δ φ}{Δ T} = [ α + \frac{1}{n} \frac{ⅆ n}{ⅆ T} ] \qquad ( 3 )$$

For an ideal athermal etalon β→0. Using conventional solid etalon materials, e.g., fused silica (Corning), β=7.09×10⁻⁶ K⁻¹. An alternative solid etalon material is the Schott glass N-LAK12 which yields: β=5.9×10⁻⁶ K⁻¹.

The following table shows possible materials for solid-state and air-spaced etalons using conventional etalon designs. As may be seen, conventional solid etalon materials have a significantly higher β than gas filled etalons.

| | Resonance | |
|---|---|---|
| | peak shift | |
| Material | (GHz/K) | β/10⁻⁶ K⁻¹ |
| Fused Silica | −1.3 | 7.1 |
| Schott N-LaK12 | −1.1 | 5.9 |
| Open Cavity air-spaced | 0.15 | −0.83 |
| (ULE spacers) | | |
| Closed Cavity air-spaced | −0.001 | 0.008 |
| (ULE spacers) | | |
| Crystalline Quartz (0001) | −0.64 | 3.5 |

According to the present invention, it is recognized that the temperature-dependent path length change for an etalon composed of j materials is simply:

$$Δ φ = {\sum }_{j} \frac{2 π {n}_{j} {d}_{j}}{λ} {β}_{j} Δ T \qquad ( 4 )$$

which indicates that for thermal path length compensation to be achieved in an etalon cavity, a plurality of materials such that the sign of the product of the β-values is negative (Πβⱼ) may be fabricated providing an etalon with a negligibly low OPL change over a range of temperatures.

To attain negative β, the condition (dn/dT)/n←α must hold even though the thermal coefficient of expansion α for nearly all useful materials is greater than zero. This condition is believed to be unattainable for catalogued commercial glasses. In accordance with the invention, however, some crystals (most of which may be birefringent) e.g., rutile (TiO₂), strontium titanate etc. may be used in combination with conventional optical glasses to meet the required condition.

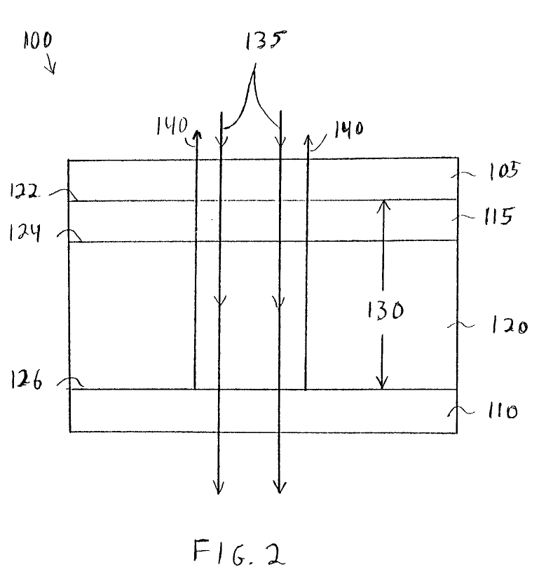

As shown in FIG. 2 an athermalized solid etalon 100 according to the present invention includes top and bottom optically transparent input and output elements 105 and 110 respectively. The solid etalon cavity comprises a first cavity element 115 having a first β value β₁ and a second cavity element 120 having a second β value, β₂. In this embodiment, there are three optical surfaces within the etalon cavity, 122, 124, 126 that may be each coated by a conventional optical coating to improve the etalon performance. Moreover, each of the elements mating at the surfaces 122, 124, 126 are preferably optically contacted together without the use of glue or other bonding or fastening materials on the mating surfaces.

The etalon 100 has a cavity length 130 that is selected to provide an appropriate optical transmission characteristic for the incoming signal beam 135 and reflection or destructive interference of the reflected beam 140. In the present embodiment the first cavity element comprises a rutile crystal cut with the a-axes lying in the incidence plane (i.e., a (0001) basal plane) to eliminate birefringence and hence two transmission spectra, each associated with the two polarizations (s and p). The second element comprises a conventional optical glass, e.g., BK7. In the case of Rutile, β=−15×10⁻⁶ K⁻¹, n_{E}=2.72 at 1550 nm and in the case of BK7 β=8.9×10⁻⁶ K⁻¹, n=1.50 at 1550 nm such that the two materials have an opposite shift in OPL with respect to temperature. To determine the thickness of each of the separate elements in a two-component system it is desirable that Δφ/ΔT→0. Thus according to equation 2, the physical thickness ratio is given by:

$$\frac{{d}_{1}}{{d}_{2}} = - \frac{{n}_{2} {β}_{2}}{{n}_{1} {β}_{1}} \qquad ( 5 )$$

From this relation, it is clear that when either d₁ or d₂ is substituted from the above relation in to the relation n₁d₁+n₂d₂=c/(2F), the etalon cavity with a Free Specral Range (FSR) of F (usually in units of GHz), the athermal condition for the etalon is fulfilled (c is the velocity of light). Compromises, however, in the choice of the two materials e.g., for de-contacting coefficient of thermal expansion (CTE) matching may be required in certain situations. Other useful materials with negative β are Strontium Titanate, PbS and KRS-5. It should be noted that the Poisson ratio and stress-optic coefficients may become significant in multi-component etalons and lower the effective value of β. The salient feature of this embodiment described is that athermal optical cavity lengths may be achieved combining any two materials with a particular thickness ratio such that in one of the materials the thermally-induced optical path length change as described by β has a negative value in the wavelength region of interest.

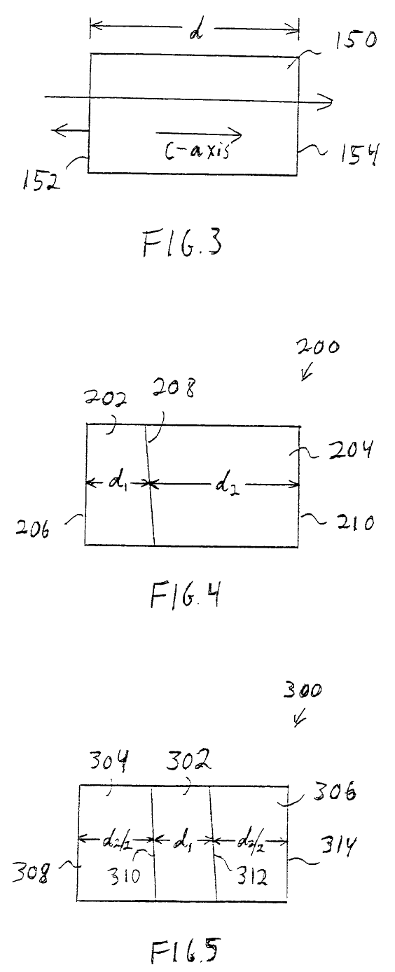

It has been discovered that a birefringent (uniaxial) material, e.g., crystalline quartz, may be used to operate as a polarization-independent etalon cavity if the crystal is cut such that a (0001) basal plane lies in the plane of incidence and the c-axis is along the direction of propagation in the cavity. Partially reflecting dielectric coatings may be deposited on each side of a quartz plate cut in the manner described above. The shift in the resonant peaks of the transmittance of the etalon may be monitored as a function of temperature between 0 and 70 degrees Celsius. A mean peak shift rate of −0.64 GHz/K (β=3.5×10⁻⁶ K⁻¹) in this temperature range has been observed. This value is a factor of two improvement on that of fused silica. For example, as shown in FIG. 3, an etalon cavity 150 of crystalline quartz may have a refractive index of n_{E} (in a direction parallel to the c-axis) and a depth d. The etalon cavity 150 also includes surfaces 152 and 154 that are coated with partial or high reflectors, and are polished in parallel with one another to within a few seconds of arc. The surfaces 152 and 154 are also the basal (0001) planes.

In accordance with an embodiment of the invention, an etalon may be formed, for example, with rutile (having β=−15×10⁻⁶ K⁻¹, n_{C}=2.72 at 1550 nm), and BK7 (having β=8.9×10⁻⁶ K⁻¹, n=1.50 at 1550 nm). The etalon may have a free spectral range of 50 GHz, for example. The cavity for such an etalon is shown in FIG. 3. The cavity 200 includes a rutile portion 202 having a refractive index of n_{c} and a depth of d₁, and a BK7 portion 204 having a refractive index of n and a depth of d₂. The exposed rutile surface 206 is a rutile (0001) plane and the optically contacted surface 208 between the rutile and BK7 includes an anti-reflective (AR) coating. The surface 208 may also be wedged with respect to the exposed surfaces 206 and 210 by up to about 0.5 degrees to avoid internal reflections from the surface 208.

As shown in FIG. 4, an etalon cavity 300 in accordance with a further embodiment of the invention may include BK7 material on either side of a rutile material. The cavity 300 includes a rutile portion 302 having a refractive index of n_{c} and a depth of d₁, a BK7 portion 304 having a refractive index of n and a depth of d₂/2 and another BK7 portion 306 having a refractive index of n and a depth of d₂/2. The exposed rutile surface 308 is a rutile (0001) plane and the optically contacted surfaces 310, 312 between the rutile and BK7 include AR coating. The surfaces 310, 312 may also be wedged with respect to the exposed surfaces 308, 314 by up to about 0.5 degrees to avoid internal reflections from the surfaces 310, 312. The etalon (−β/+β) cavity 300 provides a constant free spectral range.

Those skilled in the art will appreciate that numerous modifications and variations may be made to the above disclosed embodiments without departing from the spirit and scope of the invention.

What is claimed is:

1. An etalon comprising:
a first material having a first coefficient of thermal optical path length change β₁;
a second material having a second coefficient of thermal optical path length change β₂;
an optical path extending through said first material and said second material, wherein one of β₁ and β₂ is negative.

2. The etalon as claimed in claim 1, wherein said first material includes rutile.

3. The etalon as claimed in claim 1, wherein said first material includes a strontium titanate crystal.

4. The etalon as claimed in claim 1, wherein said second material includes an optical glass.

5. The etalon as claimed in claim 1, wherein said second material includes BK7.

6. The etalon as claimed in claim 1, wherein said second material includes a crystal.

7. The etalon as claimed in claim 1, wherein said second material includes a quartz.

8. An etalon formed of crystalline quartz such that the plane of incidence of the radiation corresponds to the (0001) basal plane of the crystal and such that the direction of propagation of the radiation is parallel to the optical (c-axis) of the crystal to within an angle of 5°.

9. An etalon comprising:
a first material having a first thickness d₁, a first index of refraction n₁, and a first coefficient of thermal optical path length change β₁;
a second material having a second thickness d₂, a second index of refraction n₂, and a second coefficient of thermal optical path length change β₂, wherein the ratio d₁/d₂ equals −(n₂β₂)/(n₁β₁).

10. The etalon as claimed in claim 9, wherein said etalon includes rutile.

11. The etalon as claimed in claim 9, wherein said etalon includes a strontium titanate crystal.

12. The etalon as claimed in claim 9, wherein said etalon includes BK7.

13. The etalon as claimed in claim 9, wherein said etalon includes a crystal.

14. The etalon as claimed in claim 9, wherein said etalon includes a quartz.

15. An etalon including strontium titanite.

16. An etalon including a coefficient of optical path length that is approximately zero.
